(19) United States
(12) Patent Application Publication
(10) Pub. No.: US 2010/0072370 A1
(43) Pub. Date: Mar. 25, 2010

(54) HUMAN MACHINE INTERFACE DEVICE AND ACTIVATING METHOD FOR BACK LIGHT UNIT THEREOF

(75) Inventor: Tse-Yu Tseng, Taipei County (TW)

Correspondence Address: COVENANT IP CONSULTING CO., P.O. BOX 34-306 TAIPEI CITY, TAIPEI, 10499, TW

(73) Assignee: BENQ CORPORATION, Taipei (TW)

(21) Appl. No.: 12/562,179

(22) Filed: Sep. 18, 2009

(30) Foreign Application Priority Data
Sep. 19, 2008 (TW) 97136025

(51) Int. Cl. G01J 5/02

(52) U.S. Cl. 250/340; 250/338.1

(57) ABSTRACT

A human-machine interface device and an activating method for a back light unit thereof are provided. The human-machine interface device includes a light sensor, an infrared sensor and a back light unit. The infrared sensor being selectively activated detects whether any part of a user body is within a sensing range when the infrared sensor is activated. When the light sensor detects that the ambient light intensity changes from a higher light intensity to a lower light intensity and the variation from the higher light intensity to the lower light intensity exceeds a predetermined light intensity difference, the infrared sensor is activated for a first period. When the activated infrared sensor detects that the part of a user body is within the sensing range, the back light unit is activated for a second period.

This application claims the benefit of Taiwan application Serial No. 97136205, filed Sep. 19, 2008, the subject matter of which is incorporated herein by reference.

### BACKGROUND OF THE INVENTION

1. Field of the Invention

The invention relates in general to a human-machine interface device and an activating method for the back light unit thereof, and more particularly to a sensor type human-machine interface device and an activating method for the back light unit thereof.

2. Description of the Related Art

Along with the rapid advance in science and technology, projector has become an indispensable part to modern people in their everyday life. Moreover, wireless operating technology has been applied to the operation of projector. Wireless operating technology enables a user to operate a projector that is a distance off the user.

Generally speaking, wireless operating technology is mostly used in a human-machine interface device separated from the projector. For example, wireless operating technology is implemented in a remote controller.

However, when using a projector, normally the curtains are closed to make the projected images become clearer to the viewers. The user would find it difficult to locate a remote controller which is left in a darker environment. Or, after the user turns off indoor light and then the ambient light intensity changes to darkness from brightness, the user would also find it difficult to locate the remote controller.

### SUMMARY OF THE INVENTION

The invention is directed to a human-machine interface device and an activating method for a back light unit thereof. The human-machine interface device automatically detects whether the ambient light intensity is too dark. If yes, the human-machine interface device activates a back light unit to emit a light towards the push-button to show the position of the human-machine interface device as well as the position of the push-button on the human-machine interface device. The method of the invention allows the user to quickly locate the human-machine interface device even in a dark environment. The human-machine interface device of the invention further has the advantage of saving power.

According to a first aspect of the present invention, a human-machine interface device is provided. The human-machine interface device includes a push-button, a light sensor, an infrared sensor and a back light unit. The light sensor is for detecting an ambient light intensity. The infrared sensor is selectively activated, and when the infrared sensor is activated, the infrared sensor detects whether the part of a user body is located within a sensing range. The back light unit is selectively activated, and when the back light unit is activated, the back light unit emits a light towards the push-button. If, at a time point Ta, the light sensor detects that (a) the ambient light intensity changes from a higher light intensity to a lower light intensity and (b) the variation from the higher light intensity to the lower light intensity exceeds a predetermined light intensity difference, then the infrared sensor is activated for a first period T1 from the time point Ta till a time point Ta+T1. If, at a time point Tb during the time period from the time point Ta till the time point Ta+T1, the activated infrared sensor detects that the part of a user body is located within the sensing range, then the back light unit is activated for a second period T2 from the time point Tb till a time point Tb+T2.

According to a second aspect of the present invention, a human-machine interface device is provided. The human-machine interface device includes a push-button, a light sensor, an infrared sensor and a back light unit. The light sensor is for detecting an ambient light intensity. The infrared sensor is selectively activated, and when the infrared sensor is activated, the infrared sensor detects whether the part of a user body is located within a sensing range. The back light unit is selectively activated, and when the back light unit is activated, the back light unit emits a light towards the push-button. If, at a time point Td, the light sensor detects that the ambient light intensity changes from being higher than a first predetermined light intensity to being lower than the first predetermined light intensity, and the infrared sensor is activated for a fourth period T4 from the time point Td till a time point Td+T4. If, at a time point Tb during the time period from the time point Td till the time point Td+T4, the activated infrared sensor detects that the part of the user body is located within the sensing range, then the back light unit is activated for a second period T2 from the time point Tb till a time point Tb+T2.

According to a third aspect of the present invention, a method of activating a back light unit of a human-machine interface device is provided. The method of activating a back light unit of a human-machine interface device includes the following steps. A human-machine interface device is provided, wherein the human-machine interface device has a push-button, a light sensor, an infrared sensor and a back light unit. The light sensor is for detecting a light intensity of an ambient where the human-machine interface device is located, and the infrared sensor is selectively activated to detect whether the part of a user body is located within a sensing range. The back light unit is selectively activated to emit a light towards the push-button. If, at a time point Ta, the light sensor detects that the ambient light intensity changes from being higher than a first predetermined light intensity to being lower than the first predetermined light intensity, then the infrared sensor is activated for a first period T1 from the time point Ta till a time point Ta+T1. If, at a time point Tb during the time period from the time point Ta till the time point Ta+T1, the activated infrared sensor detects that the part of a user body is located within the sensing range, then the back light unit is activated for a second period T2 from the time point Tb till a time point Tb+T2.

The invention will become apparent from the following detailed description of the preferred but non-limiting embodiments. The following description is made with reference to the accompanying drawings.

### BRIEF DESCRIPTION OF THE DRAWINGS

FIG. 1 shows a human-machine interface device according to an embodiment of the invention;

FIG. 2 shows a function diagram according to a human-machine interface device of the invention;

FIG. 3 shows a human-machine interface device of the present embodiment of the invention being placed on the desk;

FIG. 4A and FIG. 4B shows a method flowchart of activating a back light unit of the human-machine interface device of FIG. 1;

FIG. 5 shows an example of a wave pattern of the ambient light intensity which is applied to activate an infrared sensor of the human-machine interface device of the present embodiment of the invention;

FIG. 6 shows another example of a wave pattern of the ambient light intensity which is applied to activate an infrared sensor of the human-machine interface device of the present embodiment of the invention;

FIG. 7 shows another push-button state which is applied to activate an infrared sensor of the human-machine interface device of the present embodiment of the invention;

FIG. 8 shows an example of a wave pattern of the ambient light intensity which is applied to activate a back light unit of the human-machine interface device of the present embodiment of the invention; and

FIG. 9 shows another example of a wave pattern of the ambient light intensity which is applied to activate a back light unit of the human-machine interface device of the present embodiment of the invention.

### DETAILED DESCRIPTION OF THE INVENTION

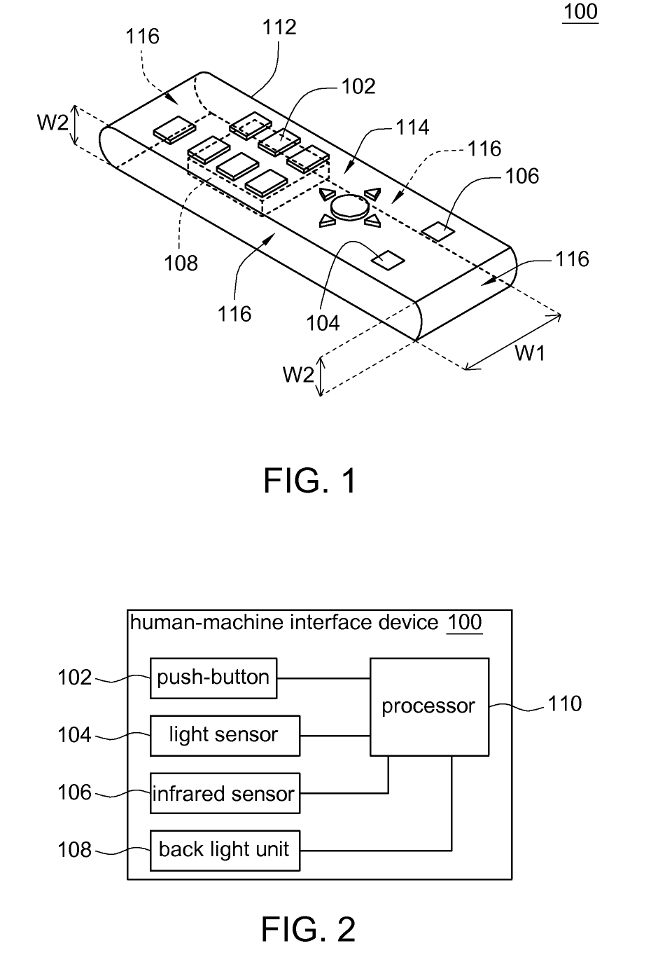

Referring to both FIG. 1 and FIG. 2. FIG. 1 shows a human-machine interface device according to an embodiment of the invention. FIG. 2 shows a function diagram according to a human-machine interface device of the invention. The human-machine interface device 100 includes a body 112, at least one push-button 102, a light sensor 104, an infrared sensor 106, a back light unit 108 and a processor 110 (not illustrated in FIG. 1). The body 112 has a body front side 114 and four body lateral sides 116, wherein the width W1 of the body front side is larger than the width W2 of the body lateral side. In the present embodiment of the invention, the human-machine interface device 100 is exemplified by a remote controller. However, the invention is not limited thereto, and the press push-button on the projector can also control the back light via the above human-machine interface device.

The light sensor 104 is for detecting an ambient light intensity. The back light unit 108 is selectively activated by the processor 110. When the back light unit 108 is activated, the back light unit 108 emits a light towards the push-button 102 so that the push-button 102 is in brightness state.

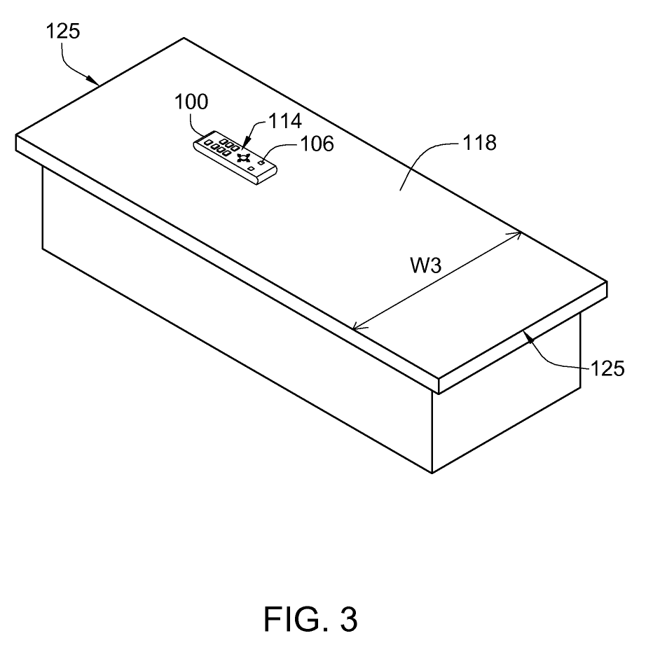

Referring to both FIG. 3, a human-machine interface device of the present embodiment of the invention being placed on the desk is shown. The infrared sensor 106, such as a passive infrared sensor, is selectively activated by the processor 110. When the infrared sensor 106 is activated, the infrared sensor 106 detects whether the part of a user body is located within a sensing range. The sensing range is less than 60 cm for example. Let the width W3 of the short side 125 of the desk 118 be 120 cm, and the human-machine interface device 100 be placed near the center of the desk 118. Thus, when the part of a user body is located at the four sides of the desk 118, the part of the user body will be outside the sensing range. Only when the part of the user body is moved to be above the desk 118, the part of the user body will be within the sensing range.

As indicated in FIG. 3, when the human-machine interface device 100 is placed on the desk 118, the body front side 114 substantially faces vertically upward. If the infrared sensor 106 disposed at the body front side 114 is activated, then the infrared sensor 106 detects whether the part of a user body (not illustrated), such as the user's hand, is moved to be above the human-machine interface device 100.

Or, the infrared sensor 106 can also be disposed outside the body front side 114. For example, the infrared sensor 106 can also disposed at the body lateral side 116 (the body lateral side 116 is illustrated in FIG. 1). When the human-machine interface device is placed on the desk 118, the body lateral side 116 faces a horizontal direction. The infrared sensor 106 detects whether the part of a user body is moved to the side of the human-machine interface device 100 and is moved to be above the desk 118.

The method of activating the back light unit 108 of the human-machine interface device 100 is disclosed below.

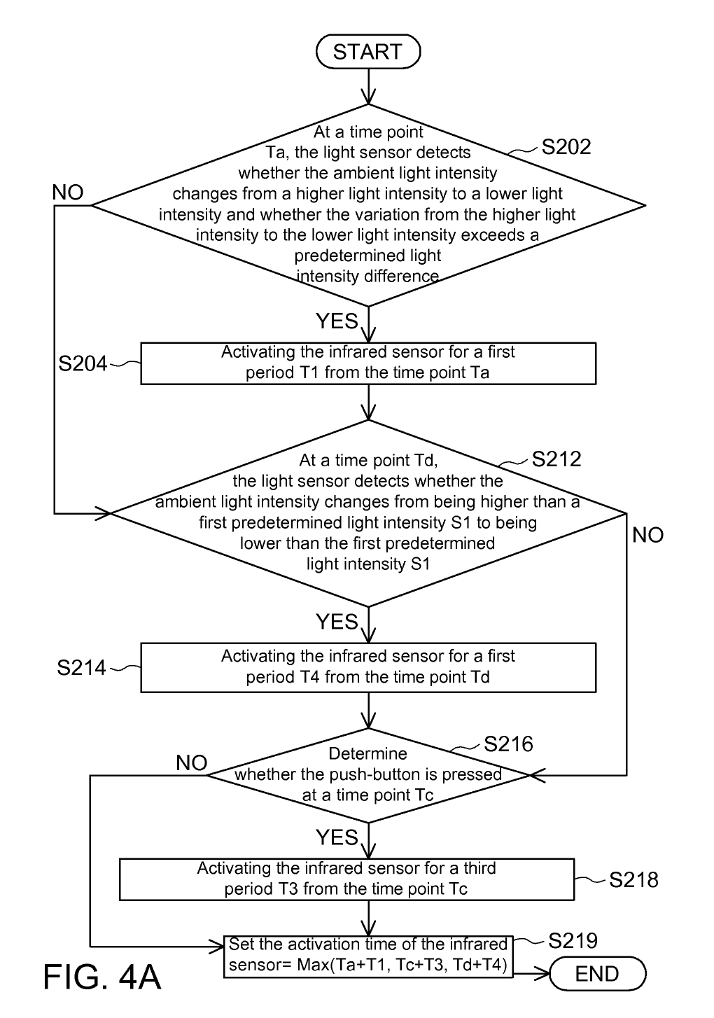

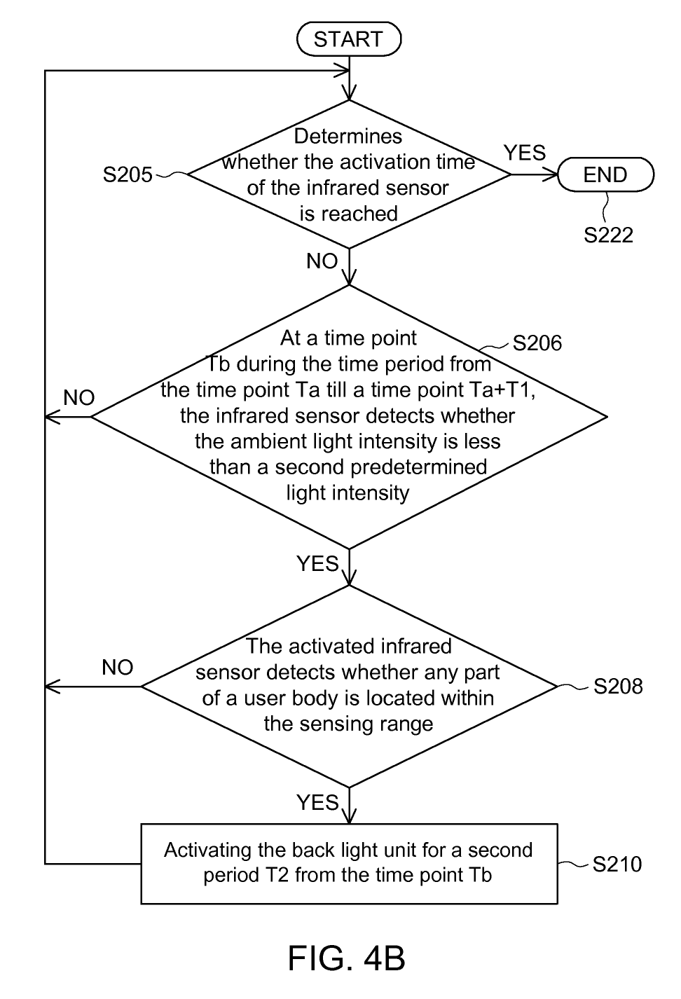

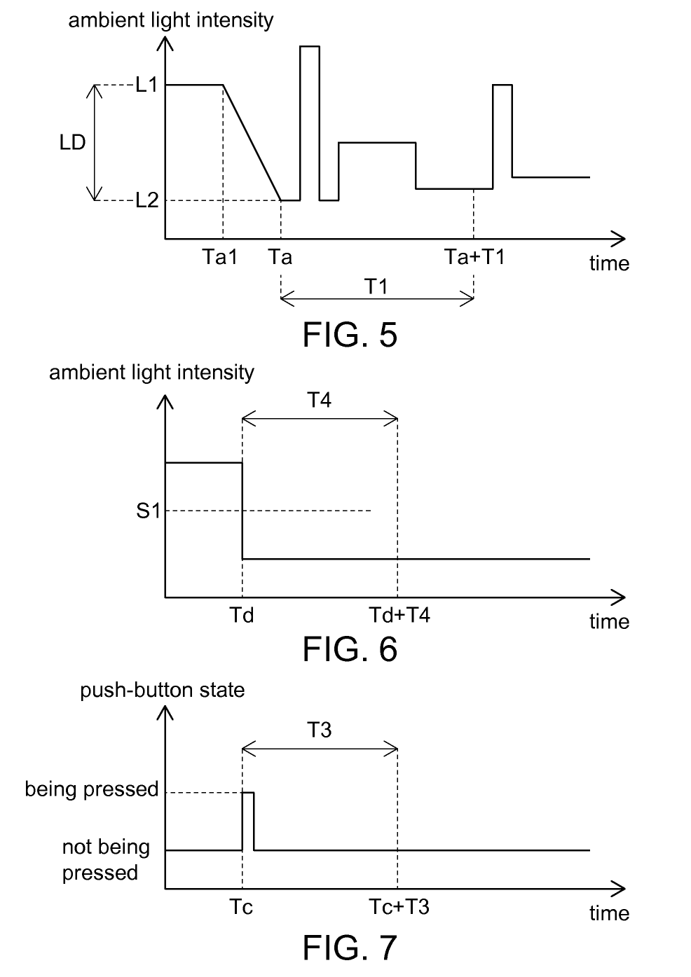

Referring to both FIG. 4A and FIG. 4B, a method flowchart of activating a back light unit of the human-machine interface device of FIG. 1 is shown. The method of activating the back light unit 108 of the human-machine interface device 100 includes the following steps. Firstly, referring to FIG. 5, an example of a wave pattern of the ambient light intensity which is applied to activate an infrared sensor of the human-machine interface device of the present embodiment of the invention is shown.

In the step S202 of FIG. 4A, the light sensor 104 detects whether the ambient light intensity changes from a higher light intensity L1 to a lower light intensity L2 and the light sensor detects whether the variation LD from the higher light intensity L1 to the lower light intensity L2 exceeds a predetermined light intensity difference. If the light sensor 104 detects that the two conditions including (1) that the ambient light intensity changes from a higher light intensity L1 to a lower light intensity L2 and (2) that the variation LD from the higher light intensity L1 to the lower light intensity L2 exceeds predetermined light intensity difference are satisfied, the method proceeds to step S204, otherwise, the method proceeds to step S212.

In step S204, if the above two conditions (1) and (2) are satisfied at a time point Ta, then the infrared sensor 106 will be activated by the processor 110 for a first period T1, such as one hour. That is, till a time point Ta+T1. Despite the first period T1 of the present embodiment of the invention is exemplified by one hour. The length of duration in other embodiments is not restricted by the exemplification in the present embodiment of the invention, as long as the length of duration enables the first period T1 to conform to the user's expected duration of use.

Referring to FIG. 6, another example of a wave pattern of the ambient light intensity which is applied to activate an infrared sensor of the human-machine interface device of the present embodiment of the invention is shown. In step S212 of FIG. 4A, the light sensor 104 detects whether the ambient light intensity changes from a higher light intensity L1 higher than the first predetermined light intensity S1 to a lower light intensity L2 lower than the first predetermined light intensity S1. If yes, the method proceeds to step S214, otherwise, the method proceeds to step S216.

In step S214, if that the ambient light intensity changes from being higher than the first predetermined light intensity S1 to being lower than the first predetermined light intensity S1 is satisfied at a time point Td, then the infrared sensor 106 will be activated by the processor 110 for a fourth period T4 from the time point Td, wherein the fourth period T4 is one hour for example. That is, the infrared sensor 106 is activated till a time point Td+T4.

Referring to FIG. 7, another push-button state which is applied to activate an infrared sensor of the human-machine interface device of the present embodiment of the invention is shown. In step S216 of FIG. 4A, the processor 110 detects whether the push-button 102 is pressed. If yes, the method proceeds to step S218, otherwise, the method directly proceeds to step S219.

In step S218, if that the push-button 102 is pressed is satisfied at a time point Tc, then the infrared sensor 106 will be activated by the processor 110 for a third period T3 from the time point Tc. The third period T3 is one hour for example. That is, the infrared sensor 106 is activated till a time point Tc+T3.

In step S219, the processor 110 sets the activation stopping time of the infrared sensor 106 to the maximum value of (Ta+T1, Tc+T3, Td+T4). Thus, the activation stopping time of the infrared sensor 106 is done in one setting.

In step S204, the predetermined light intensity difference can range between 200 and 300 lux, and the variation LD in the ambient light intensity from a higher light intensity L1 to a lower light intensity L2 is a variation measured within 5 seconds, but the invention is not limited thereto.

In step S212, the first predetermined light intensity S1 is 100 lux for example. Such a light intensity is not suitable for people to do reading with naked eyes. That is, it is hard for people to locate the human-machine interface device 100 with naked eyes under such a light intensity, and it is necessary to activate the infrared sensor 106 in order to detect the user's position and to activate the back light unit 108 timely.

Besides, if the processor 110, for a period of time, still did not receive the confirmation that any condition of the steps S202, S212, S216 is satisfied, then it is assumed that the human-machine interface device 100 or the projector is already received in a bag, a drawer, or a cabinet. At this point, the light sensor 104 detects that the ambient light intensity has little change or the light intensity before and after change is lower than a first predetermined light intensity S1. Under such circumstance, there is no need to use the infrared sensor 106 to detect the environment and the infrared sensor 106 can thus be turned off to save power. Meanwhile, the processor 110 does not need to update or set the activation stopping time of the infrared sensor 106.

That is, if the activation stopping time of the infrared sensor 106 is already reached and none of the conditions of step S202, S212, S216 is satisfied, then the infrared sensor 106 remains at disabled state, not only conforming to the user's expected duration of use, but also saving power for the infrared sensor 106.

As indicated in FIG. 4B, in step S205, the processor 110, first of all, determines whether the activation stopping time of the infrared sensor 106 is reached. If yes, the method proceeds to step S222, the infrared sensor 106 is disabled, otherwise, the method proceeds to step S206.

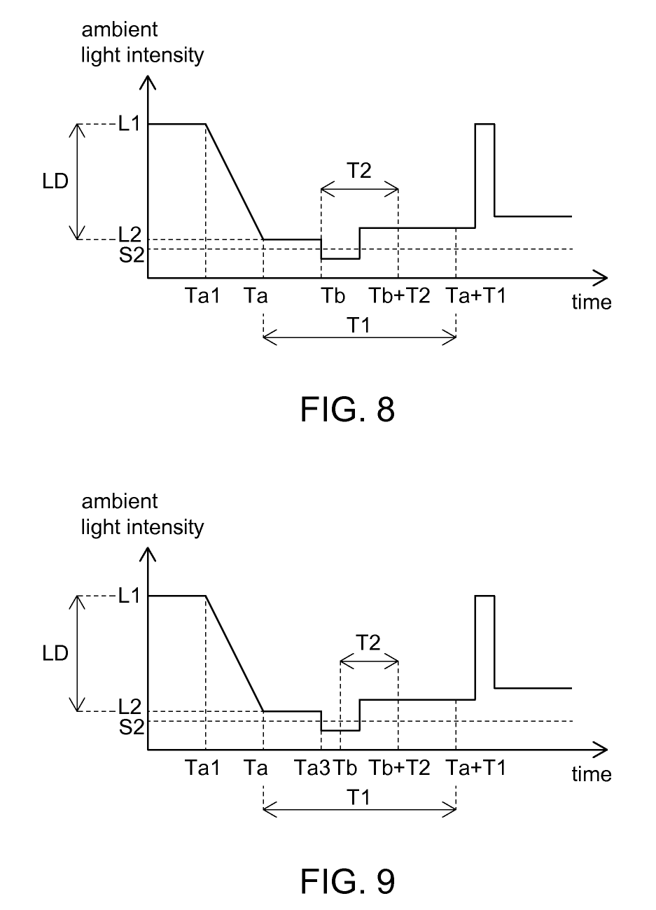

Referring to FIG. 8, an example of a wave pattern of the ambient light intensity which is applied to activate a back light unit of the human-machine interface device of the present embodiment of the invention is shown. In step S206 of FIG. 4B, the light sensor 104 detects whether the ambient light intensity is less than a second predetermined light intensity S2. If yes, the method proceeds to step S208, otherwise, the method returns to step S205.

In step S208, the activated infrared sensor 106 detects whether the part of a user body is located within the sensing range. If yes, the method proceeds to step S210, otherwise, the method returns to step S205.

In step S210, if that the infrared sensor detects the part of a user body is located within the sensing range is satisfied at a time point Tb, then the back light unit 108 will be activated for a second period T2 from the time point Tb. That is, the back light unit 108 will be activated till a time point Tb+T2, then the method returns to step S205.

Referring to FIG. 9, another example of a wave pattern of the ambient light intensity which is applied to activate a back light unit of the human-machine interface device of the present embodiment of the invention is shown. At a time point Tb, the part of a user body is detected by the infrared sensor 106 to be located within the sensing range, and meanwhile, the ambient light intensity is already less than a second predetermined light intensity S2. For example, the ambient light intensity is already less than the second predetermined light intensity S2 at a time point Tai, so the back light unit 108 is activated for a second period T2 from the time point Tb. That is, only when the infrared sensor 106 is activated and both the condition that the part of a user body is located within the detecting range D and the condition that the ambient light intensity is less than the second predetermined light intensity S2 are satisfied, the back light unit 108 will be activated.

Furthermore, suppose at a time point Ta, the user closes the curtains so that the light intensity difference of the indoor light is larger than LD, and the infrared sensor 106 will be activated for a first period T1 from the time point Ta. However, it is possible that at the time point Ta, the ambient light intensity is still higher than the second predetermined light intensity S2 of FIG. 8. As the environment is bright at this point, there is no need to activate the back light unit 108 despite the infrared sensor 106 is activated and the part of a user body already is within the sensing range.

Suppose at the time point Tb of FIG. 8 or the time point Ta3 of FIG. 9, the user turns off the indoor light to cause the indoor illumination to reduce to under the second predetermined light intensity S2. To avoid wasting power, only when the infrared sensor 106 is activated, the part of a user body is already within the sensing range, and the light sensor 104 detects that the ambient light intensity is already less than the second predetermined light intensity S2, the back light unit 108 will be activated.

Thus, within an activating period (such as the first period T1 of FIG. 5, the fourth period T4 of FIG. 6 or the third period T3 of FIG. 7) of the infrared sensor 106, only when the light sensor 104 detects that the ambient light intensity is less than the second predetermined light intensity S2 and the infrared sensor 106 detects that the part of a user body is within the sensing range, the processor 110 will activate the back light unit 110 to emit a light towards the push-button 102 so that the push-button 102 is in brightness state. Thus, even a user is in darkness, the user is still able to see the push-button 102 being in brightness state and easily locate the human-machine interface device.

The human-machine interface and activating method for the back light unit thereof disclosed in the above embodiments of the invention has many advantages exemplified below.

(1) The infrared sensor 106 is only activated for a first period T1, a third period T3 or a fourth period T4. If the infrared sensor 106 is not activated again within these periods, the infrared sensor 106 will be disabled immediately after these periods, not only conforming to the user's expected duration of use, but also saving the power for the infrared sensor 106.

(2) Only when the infrared sensor 106 is activated, the ambient light intensity is lower than a light intensity, such as a second predetermined light intensity, and the part of a user body is already within a sensing range, the back light unit 108 will be activated, not only avoiding the back light unit 108 wasting power, but also allowing the user to quickly locate the human-machine interface device even in a dark environment, hence improving the convenience of use of the human-machine interface device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A human-machine interface device, comprising:
a push-button;
a light sensor for detecting an ambient light intensity;
an infrared sensor selectively activated, wherein when the infrared sensor is activated, the infrared sensor detects whether any part of a user body is located within a sensing range; and
a back light unit selectively activated, wherein when the back light unit is activated, the back light unit emits a light towards the push-button;
wherein, if, at a time point Ta, the light sensor detects that (a) the ambient light intensity changes from a higher light intensity to a lower light intensity and (b) the variation from the higher light intensity to the lower light intensity exceeds a predetermined light intensity difference, then the infrared sensor is activated for a first period T1 from the time point Ta till a time point Ta+T1;
wherein, if at a time point Tb during the time period from the time point Ta till the time point Ta+T1, the activated infrared sensor detects that part of a user body is located within the sensing range, then the back light unit is activated for a second period T2 from the time point Tb till a time point Tb+T2.

2. The human-machine interface device according to claim 1, wherein the push-button is pressed at a time point Tc, the infrared sensor is activated for a third period T3 from the time point Tc till a time point Tc+T3.

3. The human-machine interface device according to claim 1, wherein if, at a time point Td, the light sensor detects that the ambient light intensity changes from being higher than a first predetermined light intensity to being lower than the first predetermined light intensity, then the infrared sensor is activated for a fourth period T4 from the time point Td till a time point Td+T4.

4. The human-machine interface device according to claim 1, wherein the back light unit is activated when simultaneously (1) the activated infrared sensor detects that part of the user body is located within the sensing range, and (2) the light sensor detects that the ambient light intensity is less than a second predetermined light intensity.

5. The human-machine interface device according to claim 1, wherein the variation in the ambient light intensity from the higher light intensity to the lower light intensity is a variation measured within 5 seconds.

6. The human-machine interface device according to claim 1, wherein the human-machine interface device has a body front side and a body lateral side, the width of the body front side is larger than the width of the body lateral side, and when the human-machine interface device is placed on a desk, the body front side substantially faces vertically upward, and the infrared sensor disposed at the body front side detects whether the part of a user is moved to be above the human-machine interface device.

7. The human-machine interface device according to claim 1, wherein the human-machine interface device has a body front side and a body lateral side, the width of the body front side is larger than the width of the body lateral side, and when the human-machine interface device is placed on a desk, the body lateral side faces a horizontal direction, and the infrared sensor disposed at the body lateral side detects whether the part of a user is moved to the lateral side of the human-machine interface device.

8. The human-machine interface device according to claim 8, wherein the sensing range of the infrared sensor is less than 60 cm, so that when the user is located away from the lateral edge of the desk, the user body will be outside the sensing range, when part of the user body is moved to be above the desk, part of the user body will be within the sensing range.

9. A human-machine interface device, comprising:
a push-button;
a light sensor for detecting an ambient light intensity;
an infrared sensor selectively activated, wherein when the infrared sensor is activated, the infrared sensor detects whether any part of a user body is located within a sensing range; and
a back light unit selectively activated, wherein when the back light unit is activated, the back light unit emits a light towards the push-button;
wherein, if, at a time point Td, the light sensor detects that the ambient light intensity changes from being higher than a first predetermined light intensity to being lower than the first predetermined light intensity, then the infrared sensor is activated for a fourth period T4 from the time point Td till a time point Td+T4;
wherein, if, at a time point Tb during the time period from the time point Td till the time point Td+T4, the activated infrared sensor detects that the part of the user body is located within the sensing range, then the back light unit is activated for a second period T2 from the time point Tb till a time point Tb+T2.

10. The human-machine interface device according to claim 9, wherein if the push-button is pressed at a time point Tc, then the infrared sensor from the time point Tc is activated for a third period T3 till a time point Tc+T3.

11. The human-machine interface device according to claim 9, wherein the back light unit is activated when simultaneously (1) the activated infrared sensor detects that part of the user body is located within the sensing range, and (2) the light sensor detects that the ambient light intensity is less than a second predetermined light intensity.

12. The human-machine interface device according to claim 9, wherein the first predetermined light intensity ranges between 80 and 120 lux.

13. The human-machine interface device according to claim 9, wherein the human-machine interface device has a body front side and a body lateral side, the width of the body front side is larger than the width of the body lateral side, and when the human-machine interface device is placed on a desk, the body front side substantially faces vertically upward, and the infrared sensor being disposed at the body front side detects whether any part of a user body is moved to be above the human-machine interface device.

14. The human-machine interface device according to claim 9, wherein the human-machine interface device has a body front side and a body lateral side, the width of the body front side is larger than the width of the body lateral side, and when the human-machine interface device is placed on a desk, the body lateral side faces a horizontal direction, and the infrared sensor disposed at the body lateral side detects whether any part of a user body is moved to the lateral side of the human-machine interface device.

15. The human-machine interface device according to claim 14, wherein the sensing range of the infrared sensor is less than 60 cm, so that when the user is located away from the lateral edge of the desk, the user body will be outside the sensing range, and when part of the user body is moved to be above the desk, part of the user body will be within the sensing range.

16. A method of activating a back light unit of a human-machine interface device, wherein the method comprises:
providing a human-machine interface device having a push-button, a light sensor, an infrared sensor and a back light unit, wherein the light sensor is for detecting an ambient light intensity where the human-machine interface device is located, and the infrared sensor is selectively activated to detect whether any part of a user body is located within a sensing range, and the back light unit is selectively activated to emit a light towards the push-button, the method comprises the step:
activating the infrared sensor for a first period T1 from a time point Ta till a time point Ta+T1, if, at the time point Ta, the light sensor detects that the ambient light intensity changes from being higher than a first predetermined light intensity to being lower than the first predetermined light intensity;
activating the back light unit for a second period T2 from a time point Tb till a time point Tb+T2, whenever, at the time point Tb during the time period from the time point Ta till the time point Ta+T1, the activated infrared sensor detects that part of a user body is located within the sensing range.

17. The method according to claim 16, wherein the third period is at least one hour so as to conform to the user's expected duration of use.

18. The method according to claim 16, wherein the light intensity difference ranges between 200 and 300 lux.

19. The method according to claim 16, wherein the back light unit is activated when simultaneously (1) the activated infrared sensor detects that part of the user body is located within the sensing range, and (2) the light sensor detects that the ambient light intensity is less than a second predetermined light intensity.

20. The method according to claim 16, further comprising the step:
activating the infrared sensor for a fourth period T4 from a time point Td till a time point Td+T4 if, at the time point Td, the light sensor detects that (a) the ambient light intensity changes from a higher light intensity to a lower light intensity and (b) the variation from the higher light intensity to the lower light intensity exceeds a predetermined light intensity difference.
